(19) United States
(12) Patent Application Publication
(10) Pub. No.: US 2016/0134027 A1
(43) Pub. Date: May 12, 2016

(54) TERMINAL BONDING STRUCTURE FOR WIRE AND ELECTRODE FOR RESISTANCE-WELDING

(71) Applicant: YAZAKI CORPORATION, Tokyo (JP)

(72) Inventor: Yoshitaka KODA, Kakegawa-shi (JP)

(73) Assignee: Yazaki Corporation, Tokyo (JP)

(21) Appl. No.: 14/897,288

(22) PCT Filed: Jun. 6, 2014
(86) PCT No.: PCT/JP2014/065076

§ 371 Date: Dec. 10, 2015

(30) Foreign Application Priority Data
Jun. 11, 2013 (JP) 2013-123117

(51) Int. Cl. H01R 4/02; B23K 11/30; H01R 43/02

(52) U.S. Cl. CPC H01R 4/023; H01R 43/0214; B23K 11/30

(57) ABSTRACT

A terminal bonding structure for wire (1) in which a core wire (11) of a wire (1) is resistance-welded to a connection terminal (2), wherein, core wire is formed with a thin portion (13) and a thick portion (14) respectively on a fusion bonding part (11a) and the fusion bonding part thereof is resistance-welded to the connection terminal, wherein the thin portions are formed at least at two points frontward and backward in an extension direction of the core wire, and wherein the thick portion is formed sandwiched between the thin portions and thicker than the thin portions

### TECHNICAL FIELD

The present invention relates to a bonding structure for resistance-welding a core wire of a wire to a connection terminal and an electrode.

### BACKGROUND ART

As one of techniques for bonding a wire and a connection terminal with each other, resistance-welding is known (refer to Patent Literatures 1 and 2). In such resistance-welding, a pressure energization part of an electrode is press-contacted with a core wire of the wire, the core wire is melted by Joule heat (resistance heating) which is generated by applying electric current from the pressure energization part so as to bond the melted core wire to the connection terminal. With this arrangement, compared with arc-welding and gas-welding, a welding work can be relatively easily performed.

### CITATION LIST

### Patent Literature

Patent Literature 1: Japanese Patent Laid-Open Publication No. 2009-40385

Patent Literature 2: Japanese Patent Laid-Open Publication No. 2009-123451

### SUMMARY OF INVENTION

### Technical Problem

On the other hand, for example, in the case that a core wire of a wire is resistance-welded to a connection terminal by an electrode which includes a pressure energization part in a flat state or a tilting state as disclosed in Patent Literatures 1 and 2, the melting core wire may flow to both sides (outside the pressure energization part) in an extension direction of the core wire along the pressure energization part. In this case, since a fusion bonding part (bonding target portion) of the core wire is entirely thinned by an amount of a flow, there is a possibility that long time resistance-welding may not be performed depending on the amount of the flow. Therefore, welding time cannot be sufficiently ensured and, as a result, there is a possibility that necessary bonding strength may not be obtained.

The present invention is conducted in view of the above, and the problem to be solved is to provide a terminal bonding structure for the wire capable of obtaining a sufficient bonding strength while ensuring a thickness of the fusion bonding part of the core wire, and an electrode for resistance-welding.

### Solution to Problem

To solve the problem described above, the present invention provides a terminal bonding structure of a wire in which a core wire of the wire is resistance-welded to a connection terminal, wherein, the core wire is formed with a thin portion and a thick portion respectively on a fusion bonding part of the core wire, the fusion bonding part thereof is resistance-welded to the connection terminal, wherein the thin portions are formed at least at two points frontward and backward in an extension direction of the core wire, and the thick portion is formed sandwiched between the thin portions and the thickness and thicker than the thin portions.

With this arrangement, when the fusion bonding part of the core wire is melted, the melting core wire at a part corresponding to the thin portion is accumulated at a part corresponding to a thick portion to make the part corresponding to the thick portion thicker, so that the portion corresponding to the thick portion can be raised more than the portion corresponding to the thin portion.

Therefore, it is possible to suppress a case where the melting core wire flows frontward and backward in an extension direction of the core wire, thus reducing the thickness of a whole of the fusion bonding part. Therefore, minimum thickness required (the thickness to obtain a sufficient bonding force for the resistance-welding) of the fusion bonding part during the resistance-welding can be ensured. As a result, the resistance-welding can be performed on the fusion bonding part for a long time, and thus resistance-welding of the core wire to the connection terminal can be achieved with the sufficient bonding strength.

In this case, the thin portion can include a first thin portion positioned on a front end side of the core wire and a second thin portion positioned further on a base end side of the core wire than the first thin portion and the second thin portion may be formed as thick as or thicker than the first thin portion.

In such a terminal bonding structure, the electrode is press-contacted with the core wire of the wire, and the fusion bonding part of the core wire is melted by the heat which is generated by applying the electric current from the electrode so as to be resistance-welded to the connection terminal. In that case, the electrode has a constitution including a pressure energization part respectively formed with convex portions protruding toward the fusion bonding part at least at two points frontward and backward in an extension direction of the core wire and a concave portion recessed more than the convex portions between the convex portions. With this arrangement, at least two thin portions corresponding to the convex portions and the thick portion corresponding to the concave portion are formed on the fusion bonding part respectively and the fusion bonding part can be bonded to the connection terminal.

### BRIEF DESCRIPTION OF DRAWINGS

FIG. 1 illustrates a terminal bonding structure for wire according to one embodiment of the present invention.

FIG. 2(a), FIG. 2(b), and FIG. 2(c) illustrate the terminal bonding method for wire according to the embodiment of the present invention. FIG. 2(a) is a perspective view illustrating a state in which a core wire (fusion bonding part) of a wire is placed on a connection terminal. FIG. 2(b) is a perspective view illustrating an embodiment of an electrode for resistance-welding the core wire to the connection terminal. FIG. 2(c) is a perspective view illustrating a state in which the core wire is melted to be bonded to the connection terminal.

### DESCRIPTION OF EMBODIMENTS

Hereinafter, a terminal bonding structure for a wire and an electrode for resistance-welding of the present invention will be described with reference to the drawings attached. According to the terminal bonding structure of the present invention, the melting core wire is bonded to the connection terminal by the resistance-welding.

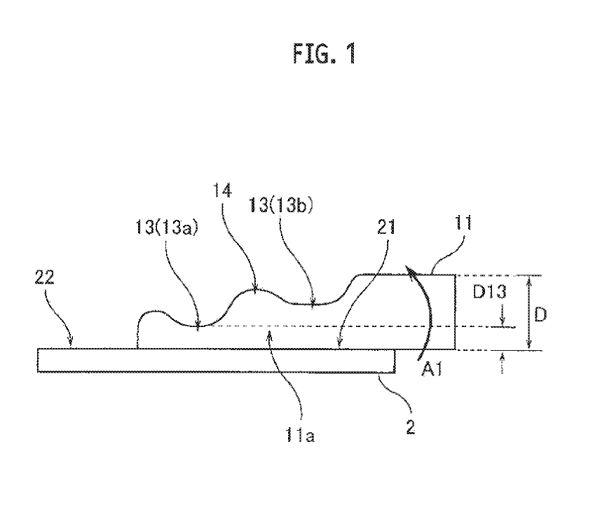

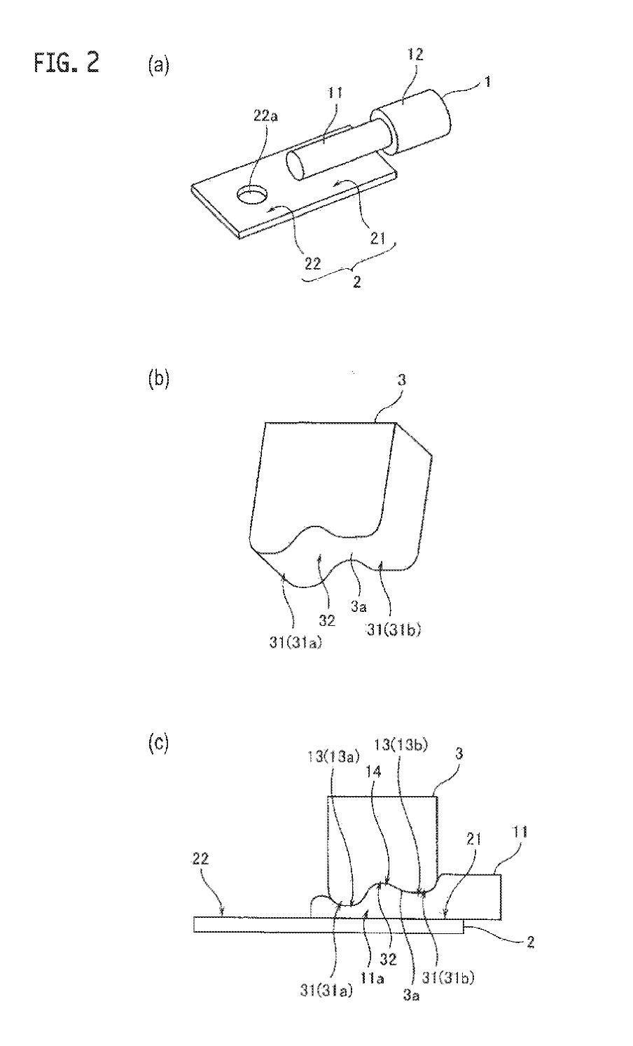

FIG. 1 shows the terminal bonding structure for the wire according to the present embodiment. Further, FIGS. 2(a), 2(b), and 2(c) illustrate a bonding method for providing the terminal bonding structure for the wire according to the present embodiment. FIG. 2(a) is a perspective view illustrating a state in which the core wire (fusion bonding part) of the wire is placed on the connection terminal. FIG. 2(b) is a perspective view illustrating a form of an electrode for resistance-welding the core wire to the connection terminal. FIG. 2(c) is a perspective view illustrating a state in which the core wire is melted to be bonded to the connection terminal. In the descriptions below, a right and left direction in FIGS. 1 and 2(c) is referred to as an extension direction of the core wire (appropriately, simply as an extension direction), a left side in each drawing is referred to as a front side in the extension direction and a front end side of the core wire (appropriately, simply as a front end side), and a right side in each drawing is referred to as a rear side in the extension direction and a base end side of the core wire (appropriately, simply as a base end side).

As illustrated in FIGS. 1, 2(a), 2(b), and 2(c), a wire 1 according to the present embodiment is constituted such that a core wire 11 is coated with an insulation coating 12. Before the core wire 11 is resistance-welded to the connection terminal 2, the wire 1 is in a state in which the insulation coating 12 is peeled off to expose the core wire, and the exposed core wire 11 is placed on a bonding part 21 of the connection terminal 2 (state illustrated in FIG. 2(a)). The core wire may be a single wire or a plurality of wires (e.g., twisted wires formed of a plurality of twisted single wires). Incidentally, FIG. 2(a) illustrates a configuration example of the core wire 11 in which the core wire 11 exposed by peeling off the insulation coating 12 is resistance-welded in an original form (substantially a columnar shape) to the bonding part 21 without being molded, although, the core wire 11 may be press-molded (pre-formed) in a predetermined shape (e.g., flat shape or a cuboid shape) in advance prior to resistance-welding.

The connection terminal 2 is formed by machining a conductive metal plate, and formed in a plate shape in which the bonding part 21 to which the core wire 11 of the wire 1 is resistance-welded and a connection part 22 having a through hole 22a for connecting to a connection counterpart device are continuous.

The core wire 11 is formed with a thin portion 13 and a thick portion 14 respectively on a fusion bonding part 11a which is a bonding target portion of the core wire 11, and the fusion bonding part 11a is resistance-welded to the bonding part 21 of the connection terminal 2. The fusion bonding part 11a includes the thin portions 13 formed at least at two points frontward and backward in the extension direction of the core wire 11, and the thick portion 14 formed sandwiched between the thin portions 13 and thicker than the thin portions 13. The thin portions 13 and the thick portion 14 described above are formed such that the core wire 11 is melted during the resistance-welding, and the fusion bonding part 11a is formed into a recessed and protruding shape at an opposite side of the bonding side (lower side illustrated in FIG. 1) with the bonding part 21. The bonding side of the fusion bonding part 11a to the bonding part 21 is bonded with the connection terminal 2 in a flat shape along the bonding part 21.

The thin portions 13, which sandwich the thick portion 14, are formed on both sides of the fusion bonding part 11a one by one in the extension direction in a continuous groove-like shape over a whole in a direction orthogonal to the extension direction. The thick portion 14 is formed by flowing the melting core wire 11 (hereinafter appropriately referred to as a “melting core wire”) from each of both sides in the extension direction across the thick portion 14 so as to make continuous protruded edges over the whole direction orthogonal to the extension direction. The thin portion 13 and the thick portion 14 are formed, when the core wire 11 has been melted, by accumulating the melting core wire corresponding to a portion of the thin portion 13 on a portion corresponding to the thick portion 14 so as to make the portion corresponding to the thick portion 14 thick. As the result, the portion corresponding to the thick portion 14 can be raised more than the portion corresponding to the thin portion 13. This suppresses a case in which the melting core wire flows frontward and backward in the extension direction, thus reducing the thickness of a whole of the fusion bonding part 11a. In other words, since the minimum thickness required (thickness for obtaining the sufficient bonding force for the resistance-welding) of the fusion bonding part 11a during the resistance-welding can be ensured, more specifically, since such a thickness of the thick portion 14 at least can be ensured, the resistance-welding on the fusion bonding part 11a can be performed for a long time. Therefore, according to the present embodiment, it is possible to sufficiently ensure the welding time, and to resistance-weld the core wire 11 to the bonding part 21 with the sufficient bonding strength.

In this case, the thick portion 14 is formed thinner than a thickness “D” of the core wire 11, and the thin portion 13 is formed thinner than the thick portion 14. At this point, the thickness of the thin portion 13 is set to be not smaller than the thickness (e.g., the thickness in which the thin portion 13 is not completely melted during the resistance-welding) to obtain a sufficient bonding force for the resistance-welding. With this arrangement, the minimum thickness required of the fusion bonding part 11a during the resistance-welding is ensured. However, in the case that the thickness of the thick portion 14 to obtain the sufficient bonding force for the resistance-welding is ensured, even if the thickness of the thin portion 13 is not more than the thickness to obtain the sufficient bonding force for the resistance-welding, at least it is possible to form the bonding structure which makes it possible to have a sufficient bonding strength with the bonding part 21 at the fusion bonding part 11a (thick portion 14).

Additionally, the fusion bonding part 11a according to the present embodiment has a configuration that includes two thin portions 13 and one thick portion 14 sandwiched between these thin portions 13, but, a modified configuration can be adopted in which three or more thin portions are formed and each thick portion is formed between adjacent thin portions. For example, in case that a dimension of the fusion bonding part in the extension direction is large, in such a modified configuration being adopted, the melting core wire can be accumulated on a plurality of thick portions. Therefore, the melting core wire flowing frontward and backward in the extension direction and thinning the entire fusion bonding part can be efficiently suppressed. Also, in the case that three or more thin portions are formed, it is preferable that each thin portion is formed in such a manner that the thicker thin portion is positioned toward the base end side from the front end side of the fusion bonding part.

In the present embodiment, the thin portions 13 include a first thin portion 13a positioned at the front end side of the core wire 11 and a second thin portion 13b positioned further on the base end side of the core wire 11 than the first thin portion 13a. The second thin portion 13b is formed as thick as or thicker than the first thin portion 13a. FIG. 1 illustrates an example of constitution that the second thin portion 13b is formed thicker than the first thin portion 13a. By adopting such a constitution described above, upon ensuring a size (thickness) of the thick portion 14 caused by difference in the thickness from the first thin portion 13a, the thickness of the second thin portion 13b can be also ensured. Therefore, while aiming at suppression of reducing the thickness of the fusion bonding part 11a caused by the flow of the melting core wire, the thickness at the base end side of the fusion bonding part 11a can be more easily ensured than that at the front end side, so that the bonding strength at the base end side can be improved. Therefore, even in the case that the thin portions 13 (first thin portion 13a and second thin portion 13b) are formed on the fusion bonding part 11a, a force acting on the wire 1 can be applied at the thin portions 13 (more specifically, the second thin portion 13b) in a direction (direction indicated with an arrow A1 illustrated in FIG. 1) where the fusion bonding part 11a is peeled off from the bonding part 21 after the resistance-welding is performed on the bonding part 21. However, it is also possible that the thickness of the second thin portion 13b is same as that of the first thin portion 13a, in other words, the thicknesses of the thin portions 13 sandwiching the thick portion 14 on both sides are the same.

Further, it is preferable that at least the thickness D13 of the first thin portion 13a is set to be not smaller than the thickness (e.g., the thickness in which the first thin portion 13a is not completely melted during the resistance-welding) to obtain the sufficient bonding force for the resistance-welding. With this arrangement, the minimum thickness required can be ensured over a whole of the fusion bonding part 11a during the resistance-welding.

Also, according to the present embodiment, the thin portions 13 (first thin portion 13a and second thin portion 13b) are formed in a recessed-curved shape and the thick portion 14 is formed in a protruding-curved shape to form a shape in which the thin portions 13 and the thick portion 14 are gradually continuous (waving shape), but, the shape is not limited to that described above. For example, the thin portion and the thick portion can be each formed continuously in a trapezoidal shape or a rectangular shape (step-like shape).

In the case that such a terminal bonding structure for the wire is adopted, according to the method described below, the thin portions 13 (first thin portion 13a and second thin portion 13b) and the thick portion 14 are formed on the fusion bonding part 11a respectively and the fusion bonding part 11a is resistance-welded to the bonding part 21 of the connection terminal 2. At this point, the electrode 3 is press-contacted with the core wire 11 of the wire 1, and the fusion bonding part 11a is melted with the heat (Joule heat) generated by applying the electric current from the electrode 3 so as to be bonded to the bonding part 21.

As illustrated in FIG. 2(b), the electrode 3 includes a pressure energization part 3a that abuts on the core wire 11 to pressurize the fusion bonding part 11a and applies the electric current to the pressurized (press-contacted) fusion bonding part 11a to generate a heat until it melts. In the pressure energization part 3a, the convex portions 31 protruding toward the fusion bonding part 11a at least at two points frontward and backward in the extension direction of the core wire 11 and the concave portion 32 recessed more than the convex portions 31 are formed between the convex portions 31. The convex portions 31 are formed on both sides in the extension direction one by one with the concave portion 32 sandwiched between the convex portions 31 so as to make continuous ridges over the whole direction orthogonal to the extension direction. Further, the concave portion 32 is formed in a groove-like shape continuously over the whole direction orthogonal to the extension direction.

According to the present embodiment, the convex portions 31 includes a first convex portion 31a positioned at the front end side to form the first thin portion 13a and a second convex portion 31b positioned further on the base end side than the first convex portion 31a to form the second thin portion 13b. The first convex portion 31a is formed to protrude more toward the fusion bonding part 11a than the second convex portion 31b. Further, according to the present embodiment, the convex portions 31 (first convex portion 31a and second convex portion 31b) are formed in a protruding-curved shape, and the concave portion 32 is formed in a recessed-curved shape and these of a shape of the convex portions 31 and the concave portion 32 are formed in gradually continuous (waving shape). In other words, the shape of the convex portions 31 and the concave portion 32 are formed corresponding to the shape of the thin portion 13 and the thick portion 14 of the fusion bonding part 11a each other respectively. The convex portions 31 and the concave portion 32 respectively form the thin portion 13 and the thick portion 14 of which shapes correspond to them. The shapes of the convex portion and the concave portion are not limited to those illustrated in FIG. 2(b). For example, the protruding dimension of the first convex portion and the second convex portion can be the same, and the convex portion and the concave portion can be continuously formed in a trapezoidal shape or a rectangular shape (step-like shape). Further, the pressure energization part can include three or more convex portions to form each one concave portion between adjacent convex portions.

In the case that the core wire 11 is resistance-welded to the bonding part 21, the fusion bonding part 11a of the core wire 11 is placed on the bonding part 21 (a state illustrated in FIG. 2(a)), and the pressure energization part 3a (face part on which the convex portions 31 and the concave portion 32 are formed) of the electrode 3 is abutted on the fusion bonding part 11a. Not being illustrated herein, the electrode which is pair with the electrode 3 is abutted on an opposite side of the bonding part 21 of the connection terminal 2. In this state, while the fusion bonding part 11a is pressurized by the abutted pressure energization part 3a, the electric current is conducted from the pressure energization part 3a to the fusion bonding part 11a. The energized fusion bonding part 11a is resistance-heated to be melted.

According to the present embodiment, since the pressure energization part 3a is formed with the convex portions 31 and the concave portion 32, the convex portions 31 and the concave portion 32 are press-contacted with the fusion bonding part 11a and the fusion bonding part 11a is melted, as the result, a flow of the melting core wire frontward and backward (outside the pressure energization part 3a) in the extension direction is suppressed (blocked) by a pair of convex portions 31 (first convex portion 31a and second convex portion 31b). The melting core wire of which flow has been suppressed is accumulated on the concave portion 32 between the first convex portion 31a and the second convex portion 31b. In other words, the melting core wire can be accumulated on the portion corresponding to the thick portion 14 from the portion corresponding to the first thin portion 13a and the second thin portion 13b of the fusion bonding part 11a respectively. With this arrangement, the portion corresponding to the thick portion 14 of the fusion bonding part 11a is made thicker so as to be raised more than the portion corresponding to the thin portion 13. As a result, the fusion bonding part 11a can be formed with the thick portion 14 and the thin portions 13 (first thin portion 13a and the second thin portion 13b) which sandwich the thick portion 14 on both sides in the extension direction. As described above, the thick portion 14 is formed sandwiched between the first thin portion 13a and the second thin portion 13b, so that thinning of the whole fusion bonding part 11a caused by the melting core wire flowing frontward and backward (outside the pressure energization part 3a) in the extension direction can be suppressed. In other words, while ensuring the minimum thickness required (thickness for obtaining the sufficient bonding force for the resistance-welding) of the fusion bonding part 11a during the resistance-welding, the resistance-welding can be performed on the fusion bonding part 11a for a long time. Therefore, the resistance-welding of the core wire 11 to the bonding part 21 with the sufficient bonding strength can be performed.

Further, in the present embodiment, since the first convex portion 31a is formed to protrude more toward the fusion bonding part 11a than the second convex portion 31b, when the fusion bonding part 11a is pressurized by the pressure energization part 3a, pressurizing the fusion bonding part 11a in such a manner sandwiched from the both sides in the extension direction can be suppressed. With this arrangement, since the fusion bonding part 11a can be resistance-welded while dispersing a force (pressing force) applied by the pressure energization part 3a from a first convex portion 31a side to a second convex portion 31b side, bonding damage of the core wire 11 can be reduced.

Incidentally, since the core wire 11 is extended from the fusion bonding part 11a to the base end side, when the fusion bonding part 11a is melted, the melted core wire is easy to flow to the front end side (frontward in the extension direction) more than to the base end side. Therefore, by forming the first convex portion 31a so as to protrude toward the fusion bonding part 11a rather than the second convex portion 31b, when the fusion bonding part 11a is melted, the melting core wire can be blocked at the first convex portion 31a efficiently and the melting core wire that is going to flow to the front end side can be accumulated at concave portion 32. Therefore, the flow of the melting core wire frontward and backward (particularly a frond side) in the extension direction can be more efficiently suppressed. In other words, the melting core wire can be efficiently flown each from the portion corresponding to the first thin portion 13a and the second thin portion 13b to the portion corresponding to the thick portion 14.

As described above, according to the terminal bonding structure for the wire 1 and the electrode for resistance-welding of the present embodiment, while ensuring the thickness of the fusion bonding part 11a of the core wire 11, it is possible to resistance-weld the core wire 11 to the bonding part 21 of the connection terminal 2 with the sufficient bonding strength.

As described above, the present invention is described based on the embodiment as illustrated in FIGS. 1, 2(a), 2(b), and 2(c), but, the above-described embodiment is only an example of the present invention. The present invention is not limited only to the configuration of the above-described embodiment. Therefore, it is obvious for those skilled in the art to conduct the present invention in modification or a modified embodiment within a scope of the gist of the present invention. It is obvious that the modification and the modified embodiment belong to the scope of the claims of the present application.

The present application claims priority based on the Japanese Patent Application No. 2013-123117 filed on Jun. 11, 2013, the entire content of which is incorporated herein by reference.

### INDUSTRIAL APPLICABILITY

According to the present invention, while ensuring the thickness of the fusion bonding part of the core wire, it is possible to realize the terminal bonding structure for wire which can obtain the sufficient bonding strength and the electrode for resistance-welding.

### REFERENCE SIGNS LIST

1 wire
2 connection terminal
11 core wire
11a fusion bonding part
13 thin portion
13a first thin portion
13b second thin portion
14 thick portion

1. A terminal bonding structure for wire in which a core wire of a wire is resistance-welded to a connection terminal,
wherein the core wire is formed with a thin portion and a thick portion respectively on a fusion bonding part of the core wire, and the fusion bonding part thereof is resistance-welded to the connection terminal,
wherein the thin portion is formed at least at two points frontward and backward in an extension direction of the core wire, and
wherein the thick portion is formed sandwiched between the thin portions and thicker than the thin portions.

2. The terminal bonding structure for wire according to claim 1,
wherein the thin portion includes a first thin portion positioned on a front end side of the core wire and a second thin portion positioned further on a base end side of the core wire than the first thin portion, and
wherein the second thin portion is formed as thick as or thicker than the first thin portion.

3. An electrode for resistance-welding for resistance-welding a core wire of a wire to a connection terminal,
wherein a pressure energization part of the electrode is respectively formed with convex portions protruding toward a fusion bonding part of the core wire at least at two points frontward and backward in an extension direction of the core wire and a concave portion which is recessed more than the convex portions between the convex portions.
